(19) United States
(12) Patent Application Publication
(10) Pub. No.: US 2017/0227144 A1
(43) Pub. Date: Aug. 10, 2017

(54) DECORATIVE ESCUTCHEONS AND FLANGES

(71) Applicant: Duane Allen Heaton, Huntington Beach, CA (US)

(72) Inventor: Duane Allen Heaton, Huntington Beach, CA (US)

(21) Appl. No.: 15/496,489

(22) Filed: Apr. 25, 2017

Related U.S. Application Data
(63) Continuation-in-part of application No. 14/943,283, filed on Nov. 17, 2015.
(60) Provisional application No. 62/329,902, filed on Apr. 29, 2016.
(60) Provisional application No. 62/082,024, filed on Nov. 19, 2014.

(51) Int. Cl. F16L 5/00

(52) U.S. Cl. CPC F16L 5/00

(57) ABSTRACT

A decorative escutcheon or flange at the joint between a surface and an appliance protrusion, hole, or valve. The flange may include a decorative and attractive plate and a stem. The stem may be coupled to a rear of the decorative and attractive plate. The decorative and attractive plate may have a hole, such that an item passed through the hole also passes through the hollow stem. The flange is configured to be inserted into an opening on a surface, such that the opening of the surface is at least partially accessible through the hole and the hollow stem.

### CROSS-REFERENCE TO RELATED APPLICATIONS

This U.S. Non-Provisional Patent Application claims the benefit of U.S. Provisional Patent Application No 62/329,902, filed on Apr. 29, 2016, titled “ESCUTCHEONS”, by sole inventor Duane Allen Heaton, the contents of which are expressly incorporated herein by this reference as though set forth in their entirety. This U.S. Non-Provisional Patent Application is also a Continuation in Part of U.S. Non-Provisional patent application Ser. No. 14/943,283, filed on Nov. 17, 2015, titled “DECORATIVE AND MAGNETIC CLEAN-OUT COVER”, by sole inventor Duane Heaton, the contents of which are expressly incorporated herein by this reference as though set forth in their entirety. U.S. Non-Provisional patent application Ser. No. 14/943,283 takes priority from U.S. Provisional Patent Application No. 62/082,024, filed on Nov. 19, 2014, titled “DECORATIVE AND MAGNETIC CLEANOUT COVER”, by sole inventor Duane Heaton, the contents of which are expressly incorporated herein by this reference as though set forth in their entirety.

### FIELD OF USE

The present disclosure relates generally to the field of covering an opening of a surface from which an appliance, valve, plumbing fixture, or portion of an appliance is protruding. More specifically, the disclosure relates to a decorative escutcheon or flange at the joint between a surface and an appliance protrusion, key hole, or valve.

### BACKGROUND

An escutcheon is a general term for a plate or cover used to conceal in-part or in-whole the opening where a functioning, non-architectural item protrudes or can be found. These items can be mechanical, electrical, and plumbing components and fixtures, such as where a pipe, tube, or conduit passes through a wall surface or is found within a shallow hole in the wall. An escutcheon may also be used to cover the gap between the outside diameter of the item and the inside diameter of the opening in the wall surface. Although some escutcheons have been decorative, such as a a light switch cover, other escutcheons, such as a showerhead cover or a gas fireplace flange have, prior to the present disclosure, been specifically decorative.

Thus, there is a need in the art for a decorative plumbing escutcheon and/or gas fireplace flange that are decorative and attractive.

### SUMMARY

To minimize the limitations in the cited references, and to minimize other limitations that will become apparent upon reading and understanding the present specification, the present specification discloses a new and improved fireplace flange and fireplace escutcheon.

One embodiment may be a fireplace flange, comprising: a substantially flat-face plate and a cylindrical stem. The cylindrical stem extends from one side of the flat-face plate. The side where the cylindrical stem extends from the flat-face plate is the bottom of the flat-face plate. The side of the flat-face plate opposite the side where the cylindrical stem extends from is the top. The fireplace flange contains a hole that may run through the length of the fireplace flange without interruption, beginning at the top of the flat-face plate, through the inside of the cylindrical stem, and out the bottom of the cylindrical stem. When the cylindrical stem is inserted into the wall hole housing a gas valve stem, the fireplace flange substantially covers the wall hole and attaches itself onto the gas valve stem or the wall. One way of attaching is via friction. The stem may partially stick out of the wall hole or, as preferred, it may be flush with wall. The fireplace flange may be permanently affixed or it may be removable from the wall hole. The flange hole preferably may allow a key to pass through and engage with a gas valve. This key allows the individual to turn the gas on and off.

One embodiment may be a decorative flange, comprising: a decorative and attractive plate; and a stem. The stem may be coupled to a rear of the decorative and attractive plate. The stem may be hollow. The decorative and attractive plate comprises a hole, such that an item passed through the hole also passes through the hollow stem. The flange may be configured to be inserted into an opening on a surface, such that the opening of the surface may be at least partially accessible through the hole and the hollow stem. The decorative and attractive plate may be substantially round. The hole may be substantially round. The hollow stem may be cylindrical. The flange may be removeably inserted into the opening on the surface. The flange may be a gas fireplace flange and the opening may be a gas fireplace valve access portal, such that the gas fireplace valve access portal may be covered by the decorative and attractive plate, but a gas fireplace valve may be still accessible. The hole may allow a gas fireplace key to access a gas fireplace valve. The hollow cylindrical stem and/or the flange may comprise screw threads for connecting to the opening. The hollow cylindrical stem and/or the flange may comprise magnets for connecting to the opening. The hollow cylindrical stem may connect to the opening via friction. The hollow cylindrical stem may connect to the opening via an adhesive. The rear of the plate may be flush with the surface when the flange may be inserted into the opening. The flange may be constructed of plastic. The flange may be constructed of stamped brass.

Another embodiment may be a decorative flange, comprising: a decorative and attractive plate; and a hollow cylindrical stem. The hollow cylindrical stem may be coupled to a rear of the decorative and attractive plate. The hollow cylindrical stem may be hollow. The decorative and attractive plate comprises a hole, such that an item passed through the hole also passes through the hollow cylindrical stem. The flange may be configured to be inserted into an opening on a surface, such that the opening of the surface may be at least partially accessible through the hole and the hollow stem. The decorative and attractive plate and the hole may be substantially round. The flange may be removeably inserted into the opening on the surface. The flange may be a gas fireplace flange and the opening may be a gas fireplace valve access portal, such that the gas fireplace valve access portal may be covered by the decorative and attractive plate, but a gas fireplace valve may be still accessible. The hollow cylindrical stem and/or the flange may comprise screw threads for connecting to the opening. The hollow cylindrical stem and/or the flange may comprise magnets for connecting to the opening.

Another embodiment may be a decorative escutcheon, comprising: a decorative and attractive plate. The decorative and attractive plate comprises a hole. The escutcheon may be coupled to a surface, such that a joint formed by an appliance protruding from the surface may be covered.

One embodiment may be a plumbing escutcheon with a decorative out face that gives an attractive appearance to the seam of a protruding plumbing fixture.

One embodiment may be a fireplace flange (or escutcheon) that have a decorative face and provides an attractive cover for a gas fireplace valve hole.

The decorative fireplace flange may be held in place by threading, magnets, friction, an adhesive, or hook and loop fasteners.

It is an object of the present disclosure to overcome the limitations of the prior art.

Other features and advantages will become apparent to those skilled in the art from the following detailed description and its accompanying drawings.

### BRIEF DESCRIPTION OF THE DRAWINGS

The drawings show illustrative embodiments, but do not depict all embodiments. Other embodiments may be used in addition to or instead of the illustrative embodiments. Details that may be apparent or unnecessary may be omitted for the purpose of saving space or for more effective illustrations. Some embodiments may be practiced with additional components or steps and/or without some or all components or steps provided in the illustrations. When different drawings contain the same numeral, that numeral refers to the same or similar components or steps.

FIG. 1 is an illustration of a perspective view of one embodiment of a decorative and attractive fireplace flange.

FIG. 2 is an illustration of a cross-section side view of one embodiment of the decorative fireplace flange.

FIG. 3 is an illustration of a perspective view of another embodiment of a decorative fireplace flange.

FIG. 4 is an illustration of a rear view of one embodiment of the decorative fireplace flange.

FIG. 5 is an illustration of a side view of one embodiment of the decorative fireplace flange.

FIG. 6 is an illustration of a cross-section side view of another embodiment of the decorative fireplace flange that comprises a threaded stem.

FIG. 7 is an illustration of a cross-section side view of another embodiment of the decorative fireplace flange that comprises a magnetic connector.

FIG. 8 is an illustration of one embodiment of a decorative and attractive fireplace flange with a key.

FIG. 9 is an illustration of a front view of one embodiment of a decorative and attractive plumbing escutcheon.

FIG. 10 an illustration of a rear view of one embodiment of a decorative and attractive plumbing escutcheon.

### DETAILED DESCRIPTION OF ILLUSTRATIVE EMBODIMENTS

In the following detailed description of various embodiments, numerous specific details are set forth in order to provide a thorough understanding of various aspects of the embodiments. However, the embodiments may be practiced without some or all of these specific details. In other instances, well-known procedures and/or components have not been described in detail so as not to unnecessarily obscure aspects of the embodiments.

While some embodiments are disclosed here, other embodiments will become obvious to those skilled in the art as a result of the following detailed description. These embodiments are capable of modifications of various obvious aspects, all without departing from the spirit and scope of protection. The Figures, and their detailed descriptions, are to be regarded as illustrative in nature and not restrictive. Also, the reference or non-reference to a particular embodiment shall not be interpreted to limit the scope of protection.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 1-10% from the indicated number or range of numbers.

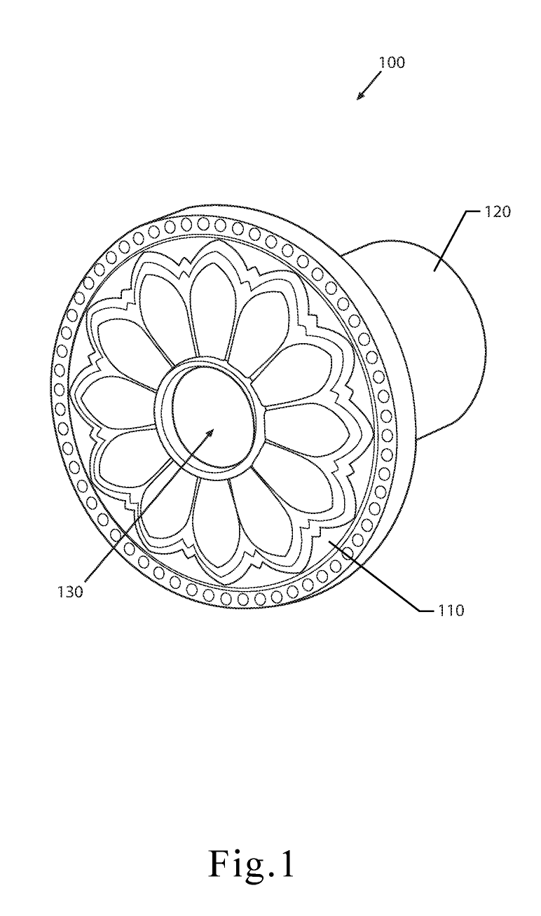

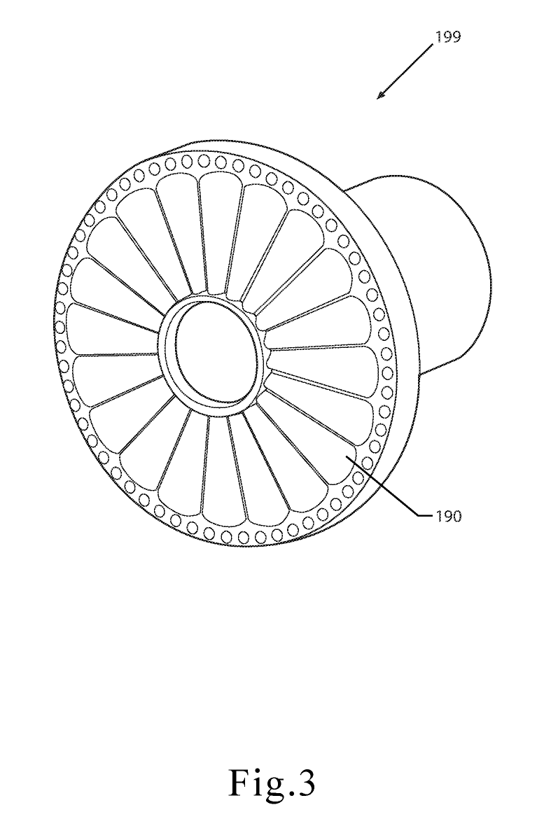

FIG. 1 is an illustration of a perspective view of one embodiment of a decorative and attractive fireplace flange. As shown in FIG. 1, one embodiment may be a decorative flange 100 that may comprise a front plate 110 and a cylindrical stem 120. As shown in FIG. 1, the front plate 110 is decorative and attractive. The cylindrical stem may extend from rear side of the flat-face plate 110. The front plate 110 may comprise an opening, such as a hole 130, which may preferably be substantially in the middle of the front plate 110. The hole 130 preferably extends through the length of the cylindrical stem 100. In this manner the flange 100 may be fitted into and be held securely by a hole in a surface. Once fitted into a hole, such as a gas fireplace access port, the hole is covered by an attractive and decorative plate 110, but the gas valve is still accessible through hole 110. Although FIG. 1 shows one embodiment of a decorative plate 110, it should be understood that different designs may be used, such as is shown in FIG. 3. Although the front plate and hole are shown as round, it should be understood that they may be square, irregular, organic, geometric, triangular, or another attractive shape. Although the stem is shown as being cylindrical, it would be understood that other shapes may be used, including square, elliptical, triangular, and the like.

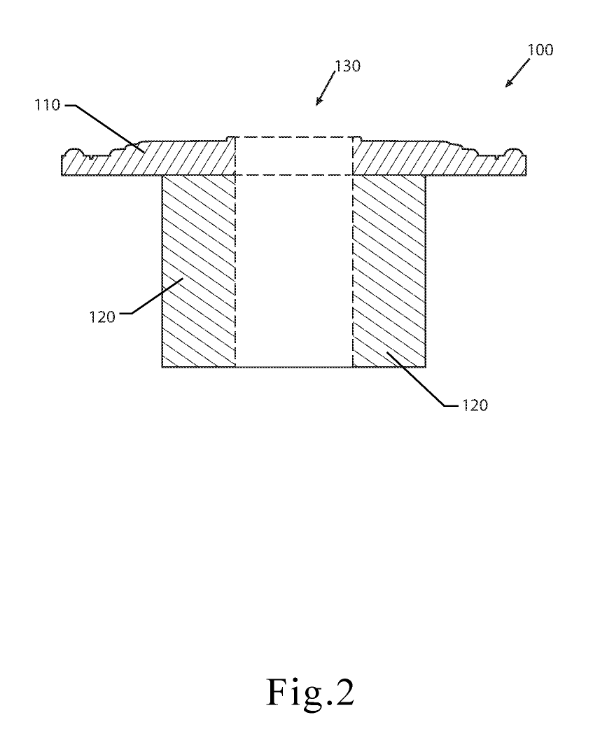

FIG. 2 is an illustration of a cross-section side view of one embodiment of the decorative fireplace flange. As shown in FIG. 2, one embodiment of the decorative fireplace flange 100 may comprise: a decorative plate 110, a cylindrical stem 120 that is hollow and extends distally away from the rear side of the plate 110. The plate 110 may have a hole 130 that extends the length of the fireplace flange 100.

FIG. 3 is an illustration of a perspective view of another embodiment of a decorative fireplace flange. FIG. 3 shows the flange 199 may have a different design plate 190.

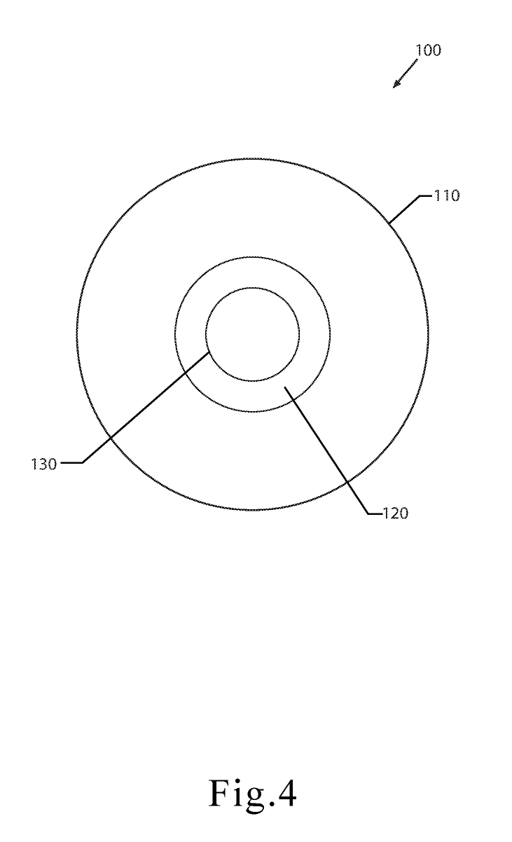

FIG. 4 is an illustration of a rear view of one embodiment of the decorative fireplace flange. As shown in FIG. 4, the cylindrical stem 120 is connected to and extends distally away from the rear of plate 110. Also shown in FIG. 4 is a hole 130 that extends the length of the fireplace flange 100.

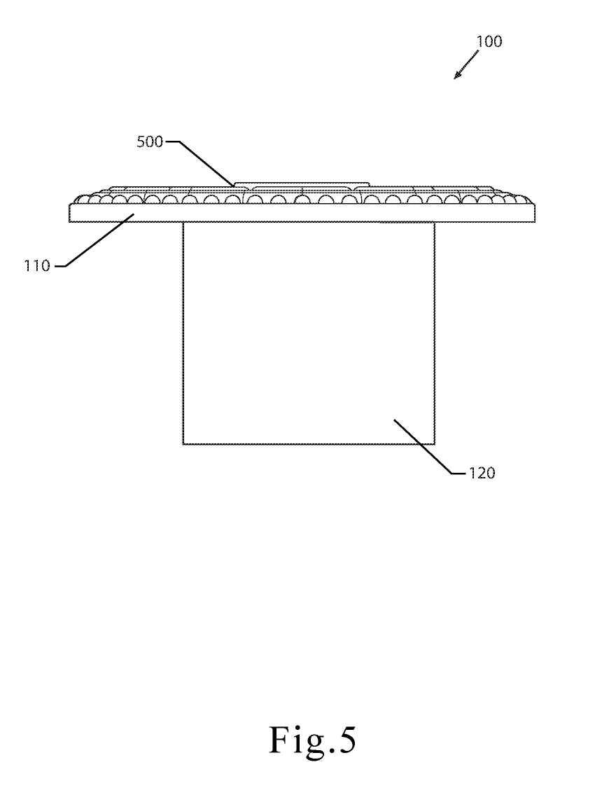

FIG. 5 is an illustration of a side view of one embodiment of the decorative fireplace flange. As shown in FIG. 5, one embodiment of the decorative fireplace flange 100 may comprise a decorative plate 110 with a cylindrical stem 120 extending from the rear of the plate 110. FIG. 5 also shows how the plate is preferably substantially flat with a decorative surface 500. Plate 110 may also be rounded, concave, convex, or domed at surface 500, so long as the hole 130 can be accessed.

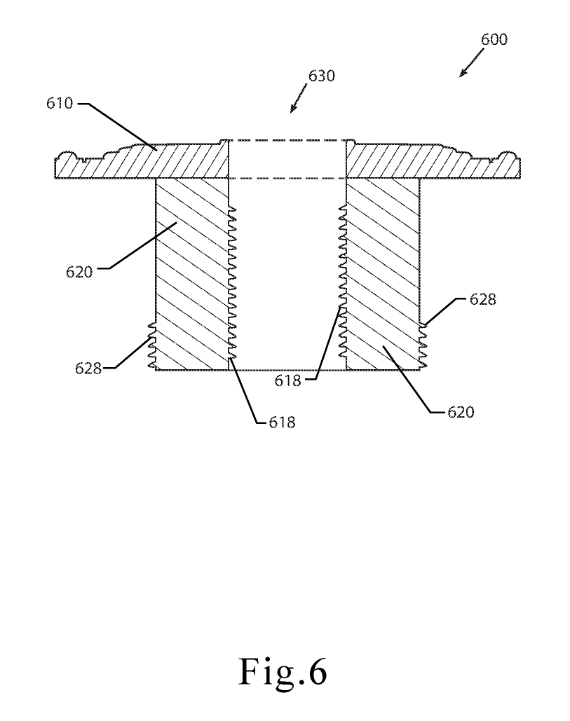

FIG. 6 is an illustration of a cross-section side view of another embodiment of the decorative fireplace flange that comprises a threaded stem. As shown in FIG. 6, one embodiment of the decorative fireplace flange 600 may comprise: a decorative plate 610 with a hole 630, and a cylindrical stem 620 that extends from the rear side of the plate 610. As shown in FIG. 6, the cylindrical stem may comprise threads 618 on the inside of the cylindrical stem 610, and/or threads 628 on the outside of stem 620. In this manner the stem 620 may be secured within a hole on a surface.

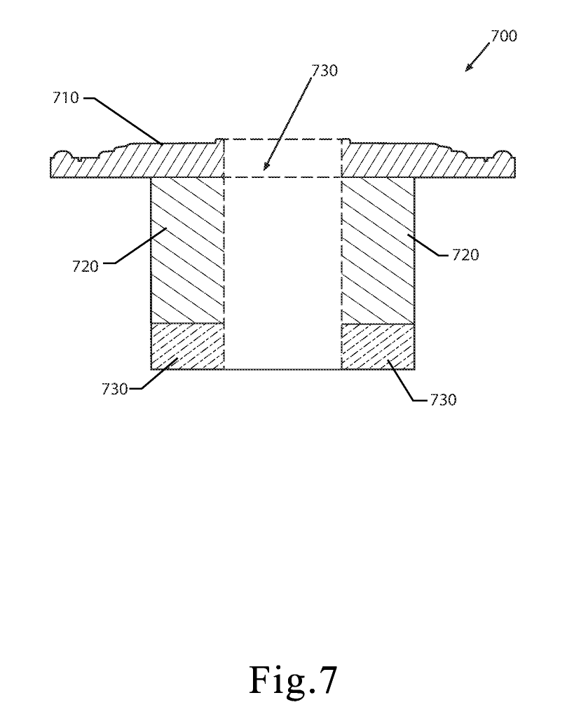

FIG. 7 is an illustration of a cross-section side view of another embodiment of the decorative fireplace flange that comprises a magnetic connector. As shown in FIG. 7, one embodiment may be a decorative fireplace flange 700 comprising: a decorative plate 110, which preferably has a hole 730, and a cylindrical stem 720 that extends from the rear side of the plate 710. FIG. 7 shows how the cylindrical stem may comprise or be connected to magnets 730, which may be used to secure the flange 700 to, for example, a gas valve access port.

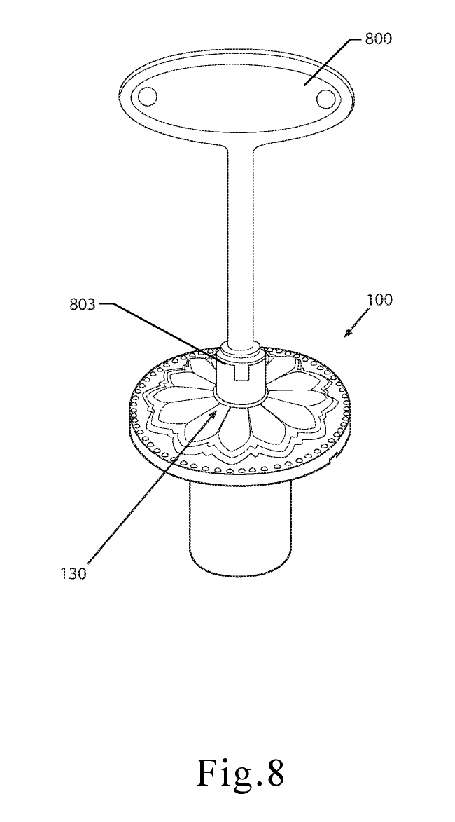

FIG. 8 is an illustration of one embodiment of a decorative and attractive fireplace flange with a key. As shown in FIG. 8, one embodiment of the decorative flange 800 may comprise a hole 830, through which a gas fireplace key may fit and access a gas valve.

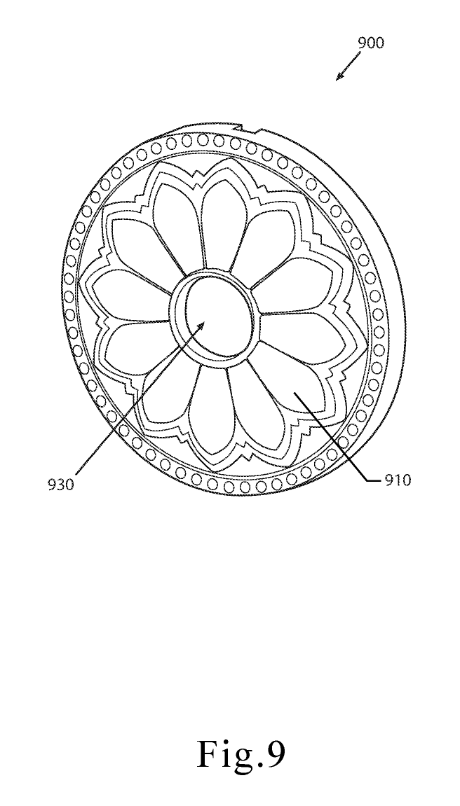

FIG. 9 is an illustration of a front view of one embodiment of a decorative and attractive plumbing escutcheon. As shown in FIG. 9, one embodiment may be a plumbing escutcheon 900 that may comprise a decorative plate 910 with a hole 930.

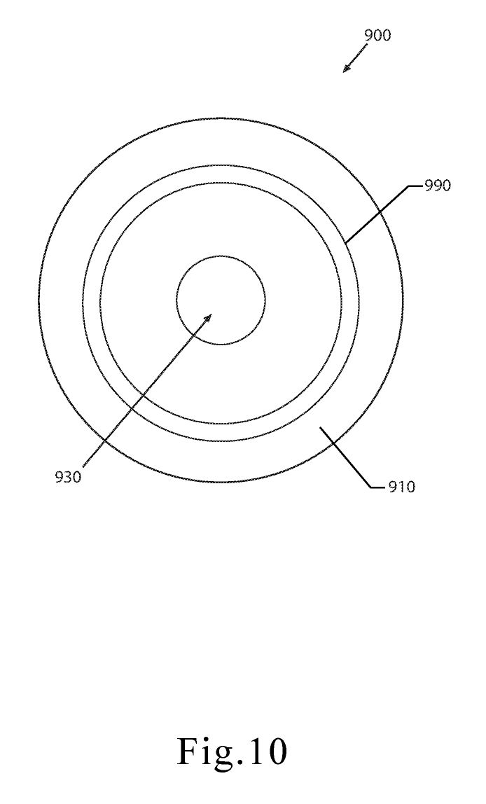

FIG. 10 an illustration of a rear view of one embodiment of a decorative and attractive plumbing escutcheon. As shown in FIG. 10, the decorative and attractive plumbing escutcheon may comprise a plate 810. The plate 910 that contains a hole 920, which allows an appliance protrusion to extend through. The plate 910 may have a connector 990 on a rear face of the plate 910, which may be an adhesive, a magnet, a hook and loop fastener, or the like.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A decorative flange, comprising:
a decorative and attractive plate; and
a stem;
wherein the stem is coupled to a rear of said decorative and attractive plate;
wherein said stem is hollow;
wherein said decorative and attractive plate comprises a hole, such that an item passed through said hole also passes through said hollow stem; and
wherein said flange is configured to be inserted into an opening on a surface, such that said opening of said surface is at least partially accessible through said hole and said hollow stem.

2. The flange of claim 1, wherein said decorative and attractive plate is substantially round.

3. The flange of claim 1, wherein said hole is substantially round.

4. The flange of claim 1, wherein said hollow stem is cylindrical.

5. The flange of claim 1, wherein said flange is removeably inserted into said opening on said surface.

6. The flange of claim 1, wherein said flange is a gas fireplace flange and said opening is a gas fireplace valve access portal, such that said gas fireplace valve access portal is covered by said decorative and attractive plate, but a gas fireplace valve is still accessible.

7. The flange of claim 5, wherein said hole allows a gas fireplace key to access a gas fireplace valve.

8. The flange of claim 1, wherein said hollow cylindrical stem comprises screw threads for connecting to said opening.

9. The flange of claim 1, wherein said hollow cylindrical stem comprises magnets for connecting to said opening.

10. The flange of claim 1, wherein said hollow cylindrical stem connects to said opening via friction.

11. The flange of claim 1, wherein said hollow cylindrical stem connects to said opening via an adhesive.

12. The flange of claim 1, wherein said rear of said plate is flush with said surface when said flange is inserted into said opening.

13. The fireplace flange of claim 1, wherein said flange is constructed of plastic.

14. The fireplace flange of claim 1, wherein said flange is constructed of stamped brass.

15. A decorative flange, comprising:
a decorative and attractive plate; and
a hollow cylindrical stem;
wherein the hollow cylindrical stem is coupled to a rear of said decorative and attractive plate;
wherein said hollow cylindrical stem is hollow;
wherein said decorative and attractive plate comprises a hole, such that an item passed through said hole also passes through said hollow cylindrical stem;
wherein said flange is configured to be inserted into an opening on a surface, such that said opening of said surface is at least partially accessible through said hole and said hollow stem;
wherein said decorative and attractive plate and said hole are substantially round.

16. The flange of claim 15, wherein said flange is removeably inserted into said opening on said surface.

17. The flange of claim 15, wherein said flange is a gas fireplace flange and said opening is a gas fireplace valve access portal, such that said gas fireplace valve access portal is covered by said decorative and attractive plate, but a gas fireplace valve is still accessible.

18. The flange of claim 15, wherein said hollow cylindrical stem comprises screw threads for connecting to said opening.

19. The flange of claim 15, wherein said hollow cylindrical stem comprises magnets for connecting to said opening.

20. A decorative escutcheon, comprising:
a decorative and attractive plate;
wherein said decorative and attractive plate comprises a hole;
wherein said escutcheon is coupled to a surface, such that a joint formed by an appliance protruding from said surface is covered.
